(19) United States
(12) Patent Application Publication
(10) Pub. No.: US 2006/0273876 A1
(43) Pub. Date: Dec. 7, 2006

(54) Over-temperature protection devices, applications and circuits

(76) Inventors: Timothy E. Pachla, Berwyn, IL (US); Stephen J. Whitney, Lake Zurich, IL (US)

Correspondence Address: Bell, Boyd & Lloyd LLC, P.O. Box 1135, Chicago, IL, 60690-1135, US

(21) Appl. No.: 11/144,238

(22) Filed: Jun. 2, 2005

(51) Int. Cl. H01H 61/06; H01H 71/18

(52) U.S. Cl. 337/140

(57) ABSTRACT

Over-temperature protection devices, over-temperature applications on substrates, such as printed circuit boards, and over-temperature protection circuits, e.g., over-temperature protection in combination with a fuse or heater are provided. In various embodiments a shape memory alloy member is used, which can either break electrical contact with a conductor (open a circuit) or make electrical contact with a conductor (close a circuit). Upon opening a first circuit, the member can move to contact another conductor and complete a second circuit. The member can close a circuit, which is in parallel with a fused load, to provide a short circuit path that opens a fuse upon an over-temperature condition occurring, e.g., within an electrical device such as a cell phone or battery. Or, the member can be provided in parallel with a heater that energizes upon an overcurrent condition, triggering the member to open a circuit.

### BACKGROUND

This application relates generally to thermal protection and more specifically to over-temperature protection devices.

It is known to use temperature sensitive shape memory alloys to provide over-temperature protection. A switch contact arm of shape memory alloy has a deformed shape at normal temperatures and changes to a recovered shape at elevated temperatures. These changes in shape provide different contact arm positions that can be used to open or close an electrical circuit.

Shape memory alloy switches have been incorporated into batteries to open the battery circuit when the battery overheats. U.S. Pat. No. 6,294,977, the entire contents of which are incorporated herein by reference, discloses such a device. That device sandwiches a contact member of shape memory alloy between a pair of electrically conductive members. Its contact member has a contact arm that opens a current path between the conductive outer members by changing between a deformed shape at normal temperatures and a recovered shape at elevated temperatures. The contact arm engages both of the conductive members when it is in its deformed shape at normal temperatures and moves out of engagement with one of the members when it is in its recovered shape at an elevated temperature.

While the above-described patent discloses one possible shape memory alloy switch, a need exists for a simpler and more generally applicable shape memory thermal switch.

### SUMMARY

Examples of the present invention discussed below provide over-temperature protection. The examples include over-temperature protection devices, over-temperature applications on substrates, such as printed circuit boards, and over-temperature protection circuits, e.g., over-temperature protection in combination with a fuse or heater. Various examples include the use of a shape memory alloy member, which can either break electrical contact with a conductor (open a circuit) or make electrical contact with a conductor (close a circuit). Upon opening a first circuit, the member can move to contact another conductor and complete a second circuit. The member can close a circuit, which is in parallel with a fused load, to provide a short circuit path that opens a fuse upon an over-temperature condition occurring, e.g., within an electrical device such as a cell phone or battery. Or, the member can be provided in parallel with a heater that energizes upon an overcurrent condition, triggering the member to open a circuit.

In particular, in a first primary embodiment, a thermal protection apparatus is provided and includes: (i) a generally planar insulative substrate; (ii) first and second conductors positioned on a side of the insulative substrate; and (iii) a shape memory alloy member having a first end fixed to the first conductor and a second end held minimally to the second conductor. Here, the member returns at least substantially to a preset shape upon reaching its activation temperature, so that the second end of the member breaks free from the second conductor and opens a circuit.

The substrate can be made of one or more materials, such as an FR-4 material, woven or non-woven glass, PTFE glass, microfiber glass, ceramic, thermoset plastic, a polyimide, Kapton® material and any combination thereof. The second end of the member can be held minimally to the second conductor via a material, such as a silver filled polymeric material or a mechanical apparatus, such as tab or clip.

The circuit can have multiple variations. In one example, the circuit is placed on a printed circuit board. The circuit can include many different types of electrical components, such as fuse, a heating element, a voltage source, and a load.

In general, the shape memory alloy is annealed to form its preset shape, which can be a coil-type shape, a kinked shape or a linear shape. In one embodiment, the member is made of a nickel-titanium alloy. The member can also be coated with a conductive material to decrease its electrical resistance. The member can be set to have any desirable activation temperature, such as about 60° C. to about 100° C.

In this first primary embodiment, the circuit that is opened can be a first circuit, and which includes a third electrode, the second end of the member contacting the third electrode and closing a second circuit after breaking free from the second conductor and opening the first circuit. Either of the first and second circuits can be of the multiple varieties described above.

In a second primary embodiment, a thermal protection apparatus is provided and includes: (i) a generally planar insulative substrate; (ii) first and second conductors positioned on a side of the insulative substrate; and (iii) a shape memory alloy member having a first end fixed to the first conductor. Here, the member returns at least substantially to a preset shape upon reaching its activation temperature, so that the second end of the member contacts the second conductor and completes a circuit.

Each of the variants discussed above for the substrate and circuit are applicable to this second primary embodiment. The second end of the member can be held to the second conductor after reaching its activation temperature via a material and/or an apparatus.

In general, the shape memory alloy is annealed to form its preset shape, which can be an uncoiled or an unkinked shape. The element can be formed after quenching to have a coiled or kinked shape. The member can be made of a nickel-titanium alloy, coated with a conductive material and/or be set to have any desirable activation temperature.

In a third primary embodiment, a thermal protection device is provided and includes: (i) an insulative housing; (ii) first and second conductors positioned on first and second ends of the housing, respectively; and (iii) a shape memory alloy member having a first end fixed to the first conductor and a second end held minimally to the second conductor. Here, the member returns to a preset shape upon reaching its activation temperature, so that the second end of the member breaks free from the second conductor and opens a circuit.

The thermal protection device can be surface-mounted through the use of: clips, pin sockets, conductive adhesive, and/or soldering with adequate heat sinking of the first and second conductors. The second end of the member can be held minimally, for example, via a material or an apparatus.

Many of the variants described above regarding the circuit and element are applicable to this third primary embodiment. Additionally, the member can be connected at its second end to a contact, which breaks free from the second conductor and opens a circuit. The second conductor can include first and second separated portions, the contact breaking free from the first and second separated portions, wherein the circuit is opened between the two portions.

In a fourth primary embodiment, a thermal protection device is provided and includes: (i) an insulative housing; (ii) first and second conductors positioned on first and second ends of the housing, respectively; and (iii) a shape memory alloy member having a first end fixed to the first conductor, a second end fixed to the second conductor, and at least one point of weakness along the member. Here, the member returns to a preset shape upon reaching its activation temperature, so that the member ruptures at least substantially at the point of weakness and opens a circuit.

Many of the variants described above regarding the circuit, the element and the mounting of the device are applicable to this fourth primary embodiment. Additionally, the one or more weak spot can be located at least substantially centrally on the member, be made of one or more perforations; and/or be made of one or more thinned area along the member.

In a fifth primary embodiment, a thermal protection device is provided and includes: (i) an insulative housing; (ii) first and second conductors positioned on first and second ends of the housing, respectively; and (iii) a shape memory alloy member having a first end and a second end. Here, the member returns to a preset shape upon reaching its activation temperature, so that the first and second ends of the member complete a circuit that is in electrical communication with the first and second conductors.

Many of the variants described above regarding the circuit, the element and the mounting of the device are applicable to this fifth primary embodiment. Additionally, the member can be connected at one or both of the first and second ends to a contact, the contact contacting one of the first and second conductors to complete the circuit. One of the first and second conductors can include first and second separated portions, the contact contacting the first and second portions, the circuit completed by bridging the two portions. The member can also be connected initially at one of its first and second ends to one of the first and second conductors, respectively, or be unconnected initially to either conductor.

In a sixth primary embodiment, a thermal protection device is provided and includes: (i) an insulative housing; (ii) first and second conductors positioned on first and second ends of the housing, respectively; (iii) a spring having a first end and a second end; and (iv) a material that holds the spring in a compressed state so that the first and second ends of the spring do not contact the first and second conductors, respectively. Here, the material deforms or melts upon reaching an activation temperature, so that the spring uncoils and the first and second ends of the spring contact the first and second conductors.

Many of the variants described above regarding the circuit and the mounting of the device are applicable to this sixth primary embodiment. Additionally, the material can be paraffin or low melting temperature poymer. The material can be configured to encase the spring in the compressed state or configured as a plug that is placed in series with the spring to hold the spring in the compressed state. Further, the spring can be made from at least one material selected from the group consisting of: stainless steel, chrome vanadium or nickel coated stainless steel.

In a seventh embodiment, a thermal protection circuit is provided and includes: (i) a voltage source; (ii) a load; (iii) a fuse placed in series with the voltage source and the load; and (iv) a thermal protection device placed in parallel with the load. Here, the thermal protection device upon reaching an activation temperature causes a short circuit resulting in an opening of the fuse. The thermal protection device can include a shape memory alloy member and be normally open [or normally closed].

The above-listed embodiments are non-exhaustive and in no way serve to limit the scope of the claims.

It is therefore an advantage of the present invention to provide improved over-temperature protection applications, devices and circuits.

It is another advantage of the present invention to provide over-temperature protection in combination with a fuse or heater.

It is a further advantage of the present invention to provide over-temperature protection that (i) makes or breaks a circuit or (ii) breaks a first circuit and makes a second circuit.

It is a yet another advantage of the present invention to provide over-temperature protection that creates a short circuit path that opens a fuse upon an over-temperature condition.

It is a yet a further advantage of the present invention to provide over-temperature protection in parallel with a heater that energizes upon an overvoltage condition, triggering the member to open or close a circuit.

Additional features and advantages of the present invention are described in, and will be apparent from, the following Detailed Description of the Invention and the figures.

### BRIEF DESCRIPTION OF THE FIGURES

FIGS. 1A and 1B are closed and opened schematic elevation views, respectively, of one embodiment of an application employing a shape memory alloy and minimal holding material or apparatus.

FIG. 1C is a schematic view of one embodiment of an application employing a shape memory alloy and a minimal holding apparatus.

FIGS. 2A and 2B are first and second schematic plan views, respectively, of one embodiment of an application employing a shape memory alloy and minimal holding material or apparatus, which form multiple conducting paths.

FIGS. 3A and 3B are closed and opened schematic sectioned elevation views, respectively, of one embodiment of a normally closed device employing a shape memory alloy and minimal holding material or apparatus.

FIGS. 4A and 4B are closed and opened schematic sectioned elevation Views, respectively, of another embodiment of a normally closed device employing a shape memory alloy and minimal holding material or apparatus.

FIGS. 5A and 5B are closed and opened schematic sectioned elevation views, respectively, of a further embodiment of a normally closed device employing a shape memory alloy.

FIGS. 6A and 6B are opened and closed schematic sectioned elevation views, respectively, of one embodiment of a normally open device employing a shape memory alloy.

FIGS. 7A and 7B are opened and closed schematic sectioned elevation views, respectively, of one embodiment of a normally open device employing a compressed spring and encapsulant material.

FIGS. 8A and 8B are opened and closed schematic sectioned elevation views, respectively, of one embodiment of a normally open device employing a shape memory alloy connected to a conductor that can short a gap between two terminals.

FIG. 9 is a schematic electrical diagram showing a thermal protection switch operable with an overcurrent protection device.

FIGS. 10A and 10 are opened and closed schematic plan views, respectively, of one embodiment of an application employing a thermal protection switch operable with an overcurrent protection device.

FIG. 11 is a schematic electrical diagram showing a thermal protection switch operable with a heater.

### DETAILED DESCRIPTION

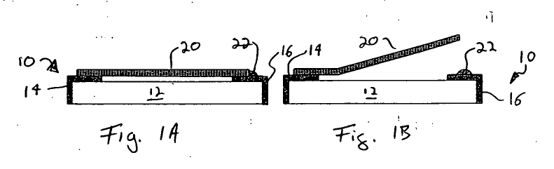

Referring now to the drawings and in particular to FIGS. 1A and 1B, an embodiment of a thermal or over-temperature protection apparatus is illustrated by apparatus 10. FIG. 1A shows apparatus 10 in a normally closed position when an over-temperature condition is not present. FIG. 1B shows apparatus 10 in a normally open position when an over-temperature condition is present.

Apparatus 10 includes a substrate 12. Substrate 12 can be made of any one or more type of rigid or semi-rigid material, such as, an FR-4 material, woven or non-woven glass, PTFE glass, microfiber glass, ceramic, thermoset plastic, a polyimide, Kapton® material, etc. Conductors 14 and 16 are placed on substrate 12 via any suitable process, such as photo-etching, plating, adhesion and any combination thereof. Conductors 14 and 16 may be placed on one surface of substrate 12 or multiple surfaces as illustrated. Conductors 14 and 16 can be made of a single metal, such as copper or be plated one or more times, for example, with one or more layers of nickel, copper, silver, gold, zinc, solder (e.g., lead-tin or lead free solder).

As illustrated, a shape memory alloy member 20 is provided. Shape member 20 (and each of the shape memory members described herein) can be of any suitable length, cross-sectional shape and cross-sectional area. The length of member 20 can be, for example, about 0.250 inch (6.35 mm) or less. The average cross-sectional length can be, for example, about 0.0472 inch (1.18 mm) or less. The cross-sectional shape can be, for example, at least substantially round, square, rectangular, ovular, etc. Other lengths, cross-sectional areas and cross-sectional shapes may also be used for member 20.

In one embodiment, member 20 is made of a nickel-titanium alloy. Other shape memory alloys can be used, however, such as copper-based ternaries including copper-zinc-aluminum and copper-nickel-aluminum. The transition temperature range at which the alloy changes from its deformed shape to its recovered shape also can be varied significantly by selecting different shape memory alloy compositions and by varying heat treating or quenching processes. In FIGS. 1A and 1B, member 20 is stamped, cut or otherwise formed to its bent shape shown in FIG. 1B, after which the alloy is annealed above its austenitic transformation temperature. Member 20 is then cooled to its martensitic state, after which member its deformed to its flat shape illustreaded in FIG. 1A.

When apparatus 10 is subjected to a transformation temperature at which martensite changes to austenite, e.g., about 60° C. to about 100° C., member 20 reverts to its recovered shape shown in FIG. 1B. In one embodiment apparatus 10 is resettable, wherein upon cooling member 20 reverts to its flat deformed shape, reestablishing electrical continuity between conductors 14 and 16. In another embodiment, apparatus 10 is non-resettable (resulting in a one-time device), wherein member 20 either remains in its recovered shape or reverts slightly but not fully to its deformed shape.

Shape memory alloys for member 20 may be selected to have a large range of transformation or transition temperatures. The transition temperature is selected to be at or just below the over-temperature condition to be protected against. For use with certain electrical devices, the transition temperatures can be about 60° C. to about 100° C., plus or minus 5° C. It will be recognized that a wide range of alloys and transformation temperatures may be chosen depending upon the application for the thermal switch assembly.

In various alternative embodiments, member 20 (and each of the shape memory members described herein) can be coated or plated with a conductive material, such as copper, other metal or conductive polymer, to reduce the overall electrical resistance or member 20, while retaining its shape memory properties. Member 20 can be made of a single strand of shape memory alloy or have multiple braided or twisted strands of shape alloy material. Further alternatively, one or more strands of shape alloy material can be twisted with one or more strands of a conductor, such as copper wire, to reduce the overall electrical resistance or member 20, while retaining its shape memory properties.

Member 20 is held firmly fixed at one end to conductor 14, via any suitable one or more mechanical, chemical or electrochemical fastening apparatus. For example, the end of member 20 can be mechanically clipped or crimped to conductor 14. For example, conductor 14 may include a socket or clip that holds fixed end of member 20. Alternatively or additionally, fixed end of member 20 may be attached to conductor 14 via a conductive adhesive. Further alternatively or additionally, fixed end of member 20 may be soldered to conductor 14, e.g., hand soldered with adequate heat sinking so as not to allow the member to reach its activation temperature.

Member 20 is minimally or releasably held at its second end to conductor 16. In FIGS. 1A and 1B, a holding material 22 is shown. Holding material may be any type of material that holds this second end of member 20 securely to conductor 16 when member 20 has not reached its activation temperature, but which allows this second end of member 20 to release or move away from conductor 16 when member 20 has reached its activation temperature. In one embodiment, material 22 includes or is a silver (or other conductive material) filled polymeric material or conductive grease.

Referring additionally to FIG. 1C, member 20 is alternatively or additionally releasably held at its second end to conductor 16 via a mechanical apparatus 24, such as a conductive clip 24. Clip 24 is adhered to conductor 16 via solder or comparable material 26 or is formed with conductor 16. Here, the releasing end of member 20 is clipped or crimped to clip 24 when member 22 has not reached its activation temperature. The releasing end of member 20 releases or moves away from clip 24 when member 20 has reached its activation temperature.

The mechanical holding device is alternatively a second piece of shape memory alloy (not illustrated) that normally holds the second end of member 20 minimally in place, but which bends or recoils upon reaching its activation temperature (which may be slightly above or below the activation temperature of member 20) to enable the second end of member 20 to disconnect electrically from conductor 16.

Under any of the scenarios described above, member 20 in FIG. 1A enables current to flow through a circuit connected to conductors 14 and 16 before member 20 reaches its activation temperature. As seen in FIG. 1B, when member 20 reaches its activation temperature, the releasing end of member 20 comes free from conductor 16, opening the circuit. This is a normally closed application. In an alternative embodiment, member 20 is constructed to be normally open, so that member 20 makes electrical contact with conductor 16 upon reaching its activation temperature.

The circuit connected to conductors 14 and 16 (for any of the embodiments described herein) may be any suitable type of circuit, such as one that is: (i) provided on a printed circuit board circuit; (ii) in electrical communication with a fuse; (iii) in electrical communication with a heating element; (iv) in electrical communication with a voltage source; and (v) part of a cell phone, digital music player, computer, battery or digital camera.

Apparatus 10 may be applied directly to a printed circuit board used with the application device. Apparatus 10 may alternatively be applied to a smaller printed circuit board (i.e., daughter board) used with the application device. Apparatus 10 may be housed or covered in a device.

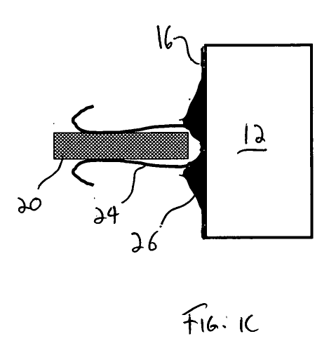

Referring now to FIGS. 2A and 2B, a second shape memory alloy over-temperature apparatus is illustrated by apparatus 30. Any of the above-described embodiments for substrate 12 is applicable to substrate 12 of apparatus 30. Any of the above-described embodiments for conductors 14 and 16 is applicable to conductors 14 to 18 of apparatus 30. Any of the above-described embodiments for material 22 (and mechanical variants) is applicable to both applications of material 22 of apparatus 30. Any of the above-described embodiments for member 20 is applicable to member 32 of apparatus 30.

Member 32 is stamped, cut or otherwise formed to its first bent shape shown in FIG. 2B, after which the alloy is annealed above its austenitic transformation temperature. Member 32 is then cooled to its martensitic state, after which member is deformed to its second bent shape illustrated in FIG. 2A. Member 32 in FIG. 2A enables current to flow through a circuit connected to conductors 14 and 16 before member 20 reaches its activation temperature. As seen in FIG. 2B, when member 32 reaches its activation temperature, the moving end of member 32 comes free from conductor 16, opening a normally closed circuit connected electrically to contacts 14 and 16. Further, the moving end of member 32 moves to and contacts third conductor 18, closing or making a normally open circuit connected electrically to contacts 14 and 18. Conductor 18 may be in communication with any suitable and desirable second circuitry, such as an alarm circuit.

As illustrated, conductor 18 may include material 22, which holds the moving end of member 32 after it comes free from conductor 16 contacts third conductor 18. Alternatively, conductor 18 includes a crimp or clip that receives member 32. In one embodiment apparatus 30 is resettable, wherein upon cooling member 32 reverts to its shape shown in FIG. 2A, reestablishing electrical continuity between conductors 14 and 16. In another embodiment, apparatus 10 is non-resettable (resulting in a one-time device), wherein member 32 either remains in its recovered shape, connected to conductor 18, or reverts slightly but not fully to its deformed shape.

Apparatus 30 may be applied directly to a printed circuit board used with the application device. Apparatus 30 may alternatively be applied to a smaller printed circuit board (i.e., daughter board) used with the application device. Apparatus 30 may be housed or covered in a device.

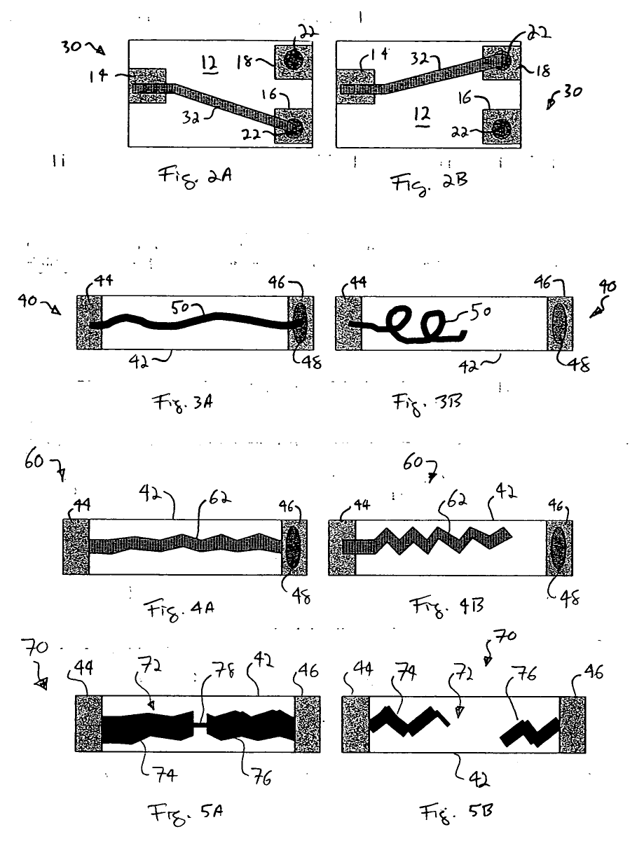

Referring now to FIGS. 3A and 3B, 4A and 4B and 5A and 5B, various embodiments of a normally closed device employing a shape memory alloy member are illustrated by devices 40, 60 and 70. Devices 40, 60 and 70 (and any devices described herein) can be of a surface mount variety and have, e.g., a length, width and height of about 3.2 mm, 1.6 mm and 0.8 mm, respectively. The pad layout for the devices in one embodiment conforms to IPC standards. In attaching the devices to a printed circuit board (“PCB”), caution needs to be paid to the activation temperature of the devices. In an embodiment, the devices are attached to the PCB via clips, pin sockets, conductive adhesive, soldering with adequate heat sinking of the leads or other apparatus or method to maintain the temperature of the shape memory member below its activation temperature.

Devices 40, 60 and 70 (and any devices described herein) can be of an axial lead version and have, e.g., a length and diameter of about 7.11 mm and 2.41 mm, respectively. Axial lead versions should be mounted to maintain the temperature of the shape memory member below its activation temperature, e.g., via sockets or adequate heat sinking of the leads during a soldering operation.

Devices 40, 60 and 70 include a number of common components. Devices 40, 60 and 70 each include an insulative housing 42. Housing 42 may be made of any suitable electrically insulative material, such as an insulative plastic, glass or ceramic. Insulative housing 42 has a melting temperature above the activation temperature of devices 40, 60 and 70. Suitable plastics for housing 42 include but are not limited to polycarbonate, poly (ether ether ketone) or poly (phenylene sulfide).

Devices 40, 60 and 70 each include conductors 44 and 46. Conductors 44 and 46 may be made or a single conductive material or include one or more plating or coating layers as discussed above with conductors 14 and 16. In an embodiment, terminations of conductors 44 and 46 include gold flash.

Each of the shape memory alloy members 50, 62 and 72 of devices 40, 60 and 70, respectively, can be of any material, construction (e.g., twisted, plated) and size discussed above for member 20. Members 50, 62 and 72 are each fixed at a first end firmly to conductor 44 via any suitable one or more mechanical, chemical or electrochemical fastening apparatus. For example, the first end of members 50, 62 and 72 can be mechanically clipped or crimped to conductor 44. In another example, conductor 14 may include a socket or clip that holds the fixed end of the members. Alternatively or additionally, fixed end of members 50, 62 and 72 may be attached to conductor 44 via a conductive adhesive. Further alternatively or additionally, fixed end of members 50, 62 and 72 may be soldered to conductor 44, e.g., hand soldered with adequate heat sinking so as not to allow the members to reach their activation temperature.

The releasing ends of members 50 and 62 of devices 40 and 60 are configured in a similar manner to that described above with apparatuses 10 and 30. A material 48 for minimally holding the releasing ends is provided above in one embodiment. Any of the embodiments described above for material 22 is applicable to material 48. Here, the releasing ends pull away from material 48 longitudinally (with respect to conductors 44 and 46, while the releasing ends of members 20 and 32 of apparatuses 10 and 30 swipe laterally away from material 22. As before, any of the above-listed embodiments for releasably or minimally mechanically holding the releasing ends of members 50 and 62 is applicable with devices 40 and 60.

With device 40, member 50 is stamped, cut and coiled to its shape shown in FIG. 3B, after which the alloy is annealed above its austenitic transformation temperature. Member 50 is then cooled to its martensitic state, after which member is deformed or elongated to its second shape illustrated in FIG. 3A. Member 50 in FIG. 3A enables current to flow through a circuit connected to conductors 44 and 46 before member 50 reaches its activation temperature. As seen in FIG. 3B, when member 50 reaches its activation temperature, the moving end of member 50 coils away from conductor 46, opening a (normally closed) circuit connected electrically to contacts 44 and 46.

Similarly, with device 60, member 62 is stamped, cut and kinked, bent or folded in an accordion like (e.g., flattened) manner to its shape shown in FIG. 4B, after which the alloy is annealed above its austenitic transformation temperature. Member 62 is then cooled to its martensitic state, after which member is deformed or elongated to its second shape illustrated in FIG. 4A. Member 62 in FIG. 4A enables current to flow through a circuit connected to conductors 44 and 46 before member 62 reaches its activation temperature. As seen in FIG. 4B, when member 50 reaches its activation temperature, the moving end of member 62 kinks, bends or folds in an accordion like manner away from conductor 46, opening a (normally closed) circuit connected electrically to contacts 44 and 46.

The opposing end 76 of member 72 of device 70 is configured differently, namely, opposing end 76 is fixed firmly to conductor 46 (via any embodiment described herein), while opposing end 74 of member 72 is fixed firmly to conductor 44. Here, no minimal holding material or apparatus is needed. Instead, one or more areas 78 of weakness is located between ends 74 and 76 of member 72. The weak area(s) 78 can: (i) be located at least substantially centrally on member 72; (ii) include one or more perforations; and/or (iii) include one or more thinned section along member 72.

With device 70, one or both ends 74 and 76 of member 72 is coiled or bent in an accordion like manner to its shape shown in FIG. 4B, after which the alloy is annealed above its austenitic transformation temperature. Member 50 is then cooled to its martensitic state, after which one or both ends 74 and 76 of member 72 is deformed or elongated to its second shape illustrated in FIG. 4A. Weak area(s) 78 may be provided before or after the quenching and elongation process

Member 72 in FIG. 4A enables current to flow through a circuit connected to conductors 44 and 46 before member 72 reaches its activation temperature. As seen in FIG. 4B, when member 72 reaches its activation temperature, the member ruptures at the weak area(s) 78, enabling ends 74 and 76 to coil or fold away from weak area(s), opening a (normally closed) circuit connected electrically to contacts 44 and 46.

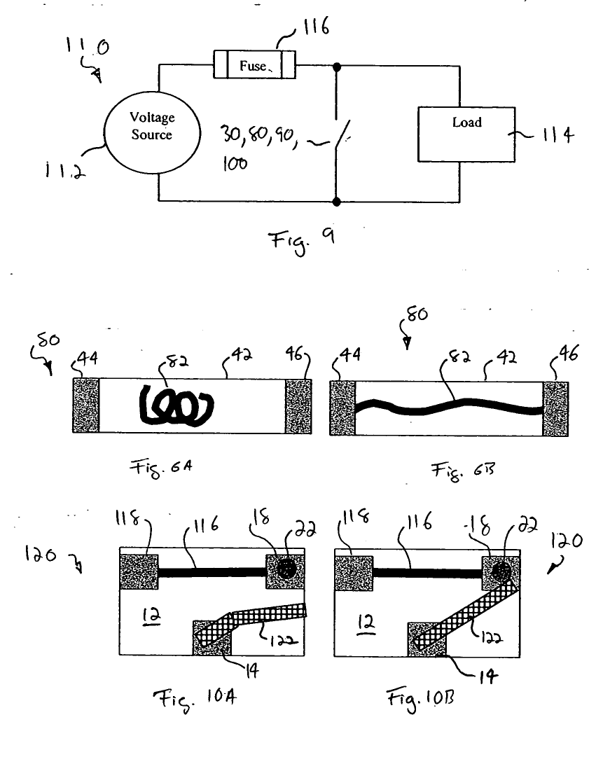

Referring now to FIGS. 6A and 6B, a first normally open device is illustrated by device 80. Device 80 includes an insulative housing 42 including all variants described above. Device 80 includes conductors 44 and 46 including all variants described above. Device 80 includes a shape memory alloy member 82, which can be of any material, construction (e.g., twisted, plated) and size discussed above.

With device 80, member 82 is stamped, cut and formed in an uncoiled, un-kinked, unbent or unfolded shape shown in FIG. 6B, after which the alloy is annealed above its austenitic transformation temperature. In this shape, member 82 is longer than the housing 42 and conductors 44 and 46 to ensure electrical contact is made upon member 82 reaching its activation temperature. Member 82 is then cooled to its martensitic state, after which member is deformed, e.g., coiled, kinked, bent or folded (e.g., in an accordion like manner) to its second shape illustrated in FIG. 6A.

As illustrated, member 82 in FIG. 6A is not long enough to touch or contact both conductors 44 and 46 and therefore does not enable current to flow through a circuit connected to conductors 44 and 46 before member 82 reaches its activation temperature. As seen in FIG. 6B, when member 82 reaches its activation temperature, member 82 uncoils, un-kinks, unbends or unfolds (e.g., in an accordion like manner) towards conductors 44 and 46, closing or completing a (normally open) circuit connected electrically to contacts 44 and 46.

Referring now to FIGS. 7A and 7B, a second normally open device is illustrated by device 90. Device 90 includes an insulative housing 42 including all variants described above. Device 90 includes conductors 44 and 46 including all variants described above. Device 90, unlike other apparatuses and devices described herein does not include a shape memory alloy member, rather, device 90 includes a conventional spring 92 (e.g., normally compressed as shown here for normally open device or normally extended for normally closed device). Spring 92 is made of any suitable conductive material, such as spring steel, which may be coated to increase conductivity. Spring 92 may have any suitable number of coils and any suitable constant k.

As illustrated, spring 92 is compressed and held within a temperature sensitive material 94. In one embodiment, material 94 is paraffin. Other suitable materials include low melting temperature polymers. Material 94 is selected so that it deforms at a desired activation temperature (e.g., 60° C. to 100° C.), which enables spring 92 to decompress. In the illustrated embodiment, material 94 surrounds spring 92 to hold spring 92 in the compressed state.

In an alternative embodiment (not illustrated), material 94 is provided as a plug that resides to the right or left of spring 92 and holds the spring against one of the conductors 44 or 46, respectively. When material reaches its activation temperature, spring 92 pushes through the plug and makes electrical contact with the other conductor 44 or 46.

As illustrated, spring 92 in FIG. 7A is not long enough to touch or contact both conductors 44 and 46 and therefore does not enable current to flow through a circuit connected to conductors 44 and 46 before material 94 reaches its activation temperature. As seen in FIG. 7B, when material 94 reaches its activation temperature, spring 92 uncoils or decompresses towards one or both conductors 44 and 46, closing or completing a (normally open) circuit connected electrically to contacts 44 and 46. As seen in FIG. 7B, material 94 may collect at the bottom of device 90. It may be preferable therefore to mount device 90 horizontally as illustrated.

In an alternative embodiment, similar to FIG. 3A, the spring is held in an extended state via material 94 so that the ends of the spring touch or contact both conductors 44 and 46 (e.g., so that the very ends of the spring extend out of material 94 to make good electrical contact with the conductors 44 and 46) enabling current to flow through a circuit connected to conductors 44 and 46 before material 94 reaches its activation temperature. When material 94 reaches its activation temperature, the spring de-energizes and coils to its normal unstressed state away from one or both conductors 44 and 46, e.g., like in FIG. 3B, opening a (normally closed) circuit connected electrically to contacts 44 and 46.

In a similar alternative embodiment, similar to FIG. 1A, the spring is held in an extended state via a fixed connection to conductor 14 and a releasable connection to conductor 16 via material 22, so that the ends of the spring touch or contact both conductors 14 and 16, enabling current to flow through a circuit connected to conductors 14 and 16 before material 22 reaches its activation temperature. Here, material 22 shown in FIGS. 1A and 1B melts. When material 22 reaches its activation temperature, the spring de-energizes and coils to its normal unstressed state away from conductor 16, e.g., like in FIG. 3B, opening a (normally closed) circuit connected electrically to conductors 14 and 16. As discussed, the spring 46 (normally coiled or normally uncoiled) in combination with the meltable material can replace many of the shape memory alloy members described herein.

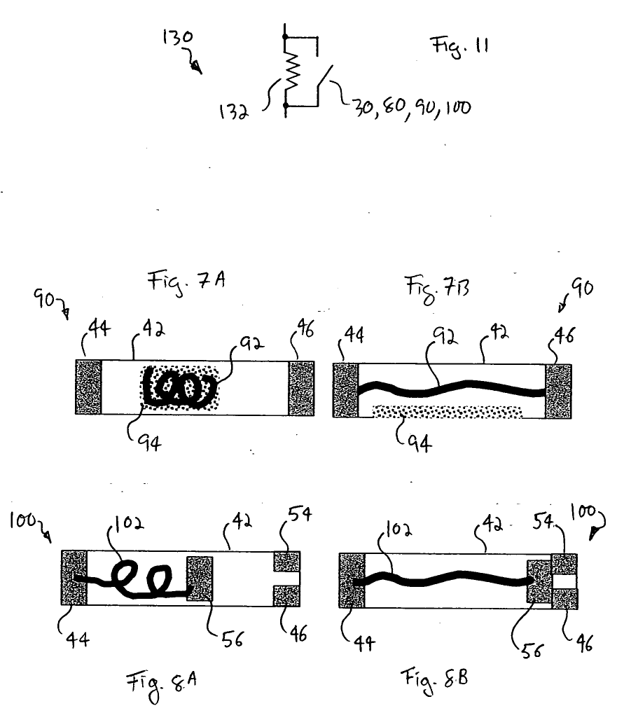

Referring now to FIGS. 8A and 8B, a third normally open device is illustrated by device 100. Device 100 includes an insulative housing 42 including all variants described above. Device 100 includes conductors 44, 46 and 54 including all variants described above. Device 100 includes a shape memory alloy member 102, which can be of any material, construction (e.g., twisted, plated) and size discussed above.

With device 100, member 102 is stamped, cut and formed in an uncoiled, un-kinked, unbent or unfolded shape shown in FIG. 8B, after which the alloy is annealed above its austenitic transformation temperature. Member 102 is then cooled to its martensitic state, after which member is deformed, e.g., coiled, kinked, bent or folded (e.g., in an accordion like manner) to its second shape illustrated in FIG. 8A.

Device 100 includes a number of variations. First, one end of device 100 includes two conductors 46 and 54 separated from one another. Second, a contact 56 is placed at the end of member 102 closer to conductors 46 and 54. Contact 56 is sized to bridge conductors 46 and 54 electrically. Contact 56 is secured to member 102 via mechanical crimping or clamping and/or soldering with suitable heat sinking so as not to bring member 102 to its activation temperature. Third, in this normally open embodiment, left end of member 102 is fixed firmly to conductor 44 via any of the embodiments described above.

As illustrated, member 102 (in combination with contact 56) in FIG. 8A is not long enough to touch or contact both conductors 44 and 46 and therefore does not enable current to flow through a circuit connected to conductors 44 and 46 (or conductors 44 and 54) before member 102 reaches its activation temperature. As seen in FIG. 8B, when member 102 reaches its activation temperature, member 102 uncoils, un-kinks, unbends or unfolds (e.g., in an accordion like manner) and along with contact 56 moves towards conductors 46 and 54. Here, a number of electrical events may take place. First, two circuits, one running through conductors 44 and 46 and one running through conductors 44 and 54 are closed or completed. Those circuits can run two different loads at least virtually simultaneously. Second, and alternatively, contact 56 can close a circuit, e.g., a short circuit, with conductors 46 and 54, for example, to open a fuse. In this second case, structure 44 may or may not be a conductor.

The operation of device 100 can be reversed, wherein member 102 (in combination with contact 56) contacts both conductors 44 and 46 and enables current to flow, for example, through a circuit connected to conductors 44 and 46 (or conductors 44 and 54) before member 102 reaches its activation temperature. In this reversed application of device 100, when member 102 reaches its activation temperature, member 102 coils, kinks, bends or folds (e.g., in an accordion like manner) and along with contact 56 moves away from conductors 46 and 54. Again, a number of electrical events may take place when member 102 moves away from conductors 46 and 54. First, two circuits, one running through conductors 44 and 46 and one running through conductors 44 and 54 are opened at least virtually simultaneously. Second, and alternatively, contact 56 can open a circuit communicating with conductors 46 and 54. Again, in this second case, structure 44 may or may not be a conductor.

Referring now to FIG. 9, one application or circuit 110 employing normally open devices 30, 80, 90 and 100 is illustrated. Circuit 110 includes a voltage source 112, a load 114 and an overcurrent device or fuse 116. Voltage source 112 in one embodiment is a DC voltage source, such as a 5 VDC, 9 VDC, 12 VDC or 24 VDC source. Voltage source 112 is alternatively an AC voltage source, such as a 120 VAC source. Load 114 can be any suitable one or more electrical or electronic device, such as one or more component of a cell phone, digital music player, computer, battery or digital camera. Overcurrent device 116 is rated for a desired amperage, such as 2 amps. Overcurrent device 116 can be any suitable type of fuse, such as surface mount or axially leaded. Overcurrent device 116 is alternatively of a resettable polymer temperature coefficient type.

Under normal temperatures and normal current flow, voltage source 112 powers load 114 via circuit 110. Upon an overcurrent condition, fuse 116 opens, protecting load 114 from the condition. Upon an over-temperature condition, as sensed by device 30, 80, 90 or 100, the over-temperature device closes and creates a short or low impedance path across load 114. The short circuit opens fuse 116, removing power from load 114. In one embodiment, load 114 can be a component susceptible to overheating, such as a resistor, inductor, semiconductor or battery, wherein circuit 110 removes power from load 114 and preventing further overheating. Here, circuit 110 serves to protect components located near load 114.

In one embodiment, device 30, 80, 90 or 100 is integrated with load 114. In another embodiment, device 30, 80, 90 or 100 is coupled to load 114. In a further embodiment, device 30, 80, 90 or 100 is located directly adjacent to load 114. In yet another embodiment, device 30, 80, 90 or 100 is coupled with overcurrent device 116, wherein the over-temperature device accelerates the opening of overcurrent device 116, e.g., in the event of an extended low level overload.

Referring now to FIGS. 10A and 10B, a combination overcurrent and shape memory alloy over-temperature apparatus is illustrated by apparatus 120. Any of the above-described embodiments for substrate 12 is applicable to substrate 12 of apparatus 120. Any of the above-described embodiments for conductors 14, 16 and 18 is applicable to conductors 14, 18 and 118 of apparatus 120. Any of the above-described embodiments for material 22 (including mechanical variants) is applicable to material 22 of apparatus 120. Any of the above-described embodiments for any of the members is applicable to member 122 of apparatus 120.

Member 122 is stamped, cut or otherwise formed to its at least substantially straight shape shown in FIG. 10B, after which the alloy is annealed above its austenitic transformation temperature. Member 122 is then cooled to its martensitic state, after which member is deformed to its bent shape illustrated in FIG. 10A. Member 122 in FIG. 10A does not enable current to flow through a circuit connected to conductors 14 and 18 before member 122 reaches its activation temperature. As seen in FIG. 10B, when member 122 reaches its activation temperature, the moving end of member 122 moves to and contacts conductor 18, closing or making a (normally open) circuit connected electrically to contacts 14 and 18.

As illustrated, conductor 18 may include material 22, which holds the moving end of member 122 after it contacts third conductor 18. Alternatively, conductor 18 includes a crimp or clip that receives member 122. In one embodiment apparatus 120 is resettable, wherein upon cooling member 122 reverts to its shape shown in FIG. 10A, breaking electrical continuity between conductors 14 and 18. In another embodiment, apparatus 120 is non-resettable (resulting in a one-time apparatus), wherein member 122 either remains in its recovered shape, connected to conductor 18, or reverts slightly but not fully to its deformed shape.

Conductor 118 is connected via fuse or overcurrent device 116 to conductor 118. Upon an over-temperature condition, member 122 closes a circuit between conductors 14, 18 and 118. This circuit can be a short circuit, which as described above in connection with FIG. 9 opens overcurrent device 116, cutting power to a load in communication with conductors 18 and 118. Device 120 may be used for any of the applications describe above in connection with FIG. 9.

In one embodiment, device 120 is integrated with the load (not illustrated). In another embodiment, device 120 is coupled to the load. In a further embodiment, device 120 is located directly adjacent to the load.

Referring now to FIG. 11, one application or circuit 130 employing normally open devices 30, 80, 90 and 100 is illustrated. Circuit 130 includes one of those devices in electrical and thermal communication with a heater 132, such as resistive heater. Heater 132 in one embodiment is a resistive film applied to an inner or outer wall of device 30, 80, 90 and 100. Or, insulative housing 42 may act as heater 132, for example, be made of a resistive material, such as a carbon/ceramic composite.

On an extended overvoltage condition, heater 132 generates heat to help activate the temperature sensitive alloy or material, e.g., paraffin, of device 30, 80, 90 and 100. Once device 30, 80, 90 and 100 closes, it clamps the overvoltage and/or opens an overcurrent device. Heater 132 may be used alternatively with the normally closed over-temperature devices described herein, e.g., devices 40, 60 and 70, to open a circuit upon an extended overvoltage condition.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A thermal protection apparatus comprising:
a generally planar insulative substrate;
first and second conductors positioned on a side of the insulative substrate; and
a shape memory alloy member having a first end fixed to the first conductor and a second end held minimally to the second conductor, the member returning at least substantially to a preset shape upon reaching its activation temperature so that the second end of the member breaks free from the second conductor and opens a circuit.

2. The thermal protection apparatus of claim 1, wherein the substrate is made of a material selected from the group consisting of: FR-4 material, woven or non-woven glass, PTFE glass, microfiber glass, ceramic, thermoset plastic, a polyimide, Kapton® material and any combination thereof.

3. The thermal protection apparatus of claim 1, wherein the second end of the member is held minimally to the second conductor via: a material or an apparatus.

4. The thermal protection apparatus of claim 1, wherein the circuit is at least one of: (i) provided on a printed circuit board circuit; (ii) in electrical communication with a fuse; (iii) in thermal communication with a heating element; (iv) in electrical communication with a voltage source; and (v) in electrical communication with a load.

5. The thermal protection apparatus of claim 1, wherein the shape memory alloy member is at least one of: (i) coated with a conductive material to decrease electrical resistance; (ii) annealed to form its preset shape; (iii) made of a nickel-titanium alloy; (iv) configured to have an activation temperature of about 60° C. to about 100° C.; (v) preset to have a coil-type shape; and (vi) preset to have a kinked shape.

6. The thermal protection apparatus of claim 1, wherein the circuit is a first circuit, and which includes a third electrode, the second end of the member contacting the third electrode and closing a second circuit after breaking free from the second conductor and opening the first circuit.

7. A thermal protection apparatus comprising:
a generally planar insulative substrate;
first and second conductors positioned on a side of the insulative substrate; and
a shape memory alloy member having a first end fixed to the first conductor, the member returning at least substantially to a preset shape upon reaching its activation temperature so that the second end of the member contacts the second conductor and completes a circuit.

8. The thermal protection apparatus of claim 7, wherein the substrate is made of a material selected from the group consisting of: FR-4 material, woven or non-woven glass, PTFE glass, microfiber glass, ceramic, thermoset plastic, a polyimide, a Kapton® material and any combination thereof.

9. The thermal protection apparatus of claim 7, wherein the second end of the member is held to the second conductor after reaching its activation temperature via: a material or an apparatus.

10. The thermal protection apparatus of claim 7, wherein the circuit is at least one of: (i) provided on a printed circuit board circuit; (ii) in electrical communication with a fuse; (iii) in thermal communication with a heating element; (iv) in electrical communication with a voltage source; and (v) in electrical communication with a load.

11. The thermal protection apparatus of claim 7, wherein the shape memory alloy member is at least one of: (i) coated with a conductive material to decrease electrical resistance; (ii) annealed to form its preset shape; (iii) made of a nickel-titanium alloy; (iv) configured to have an activation temperature of about 60° C. to about 100° C.; (v) preset to have an uncoiled or unkinked shape; (vi) formed after annealing to have a coiled shape; and (vii) formed after annealing to have a kinked shape.

12. A thermal protection device comprising:
an insulative housing;
first and second conductors positioned on first and second ends of the housing, respectively; and
a shape memory alloy member having a first end fixed to the first conductor and a second end held minimally to the second conductor, the member returning to a preset shape upon reaching its activation temperature so that the second end of the member breaks free from the second conductor and opens a circuit.

13. The thermal protection device of claim 12, which is surface mountable via at least one of: clips, pin sockets, conductive adhesive, and soldering with adequate heat sinking of the first and second conductors.

14. The thermal protection device of claim 12, wherein the second end of the member is held minimally to the second conductor via: a material or an apparatus.

15. The thermal protection device of claim 12, which is configured to operate with the circuit, the circuit being at least one of: (i) provided on a printed circuit board circuit; (ii) in electrical communication with a fuse; (iii) in thermal communication with a heating element; (iv) in electrical communication with a voltage source; and (v) in electrical communication with a load.

16. The thermal protection device of claim 12 wherein the shape memory alloy member is at least one of: (i) coated with a conductive material to decrease electrical resistance; (ii) annealed to form its preset shape; (iii) made of a nickel-titanium alloy; (iv) configured to have an activation temperature of about 60° C. to about 100° C.; (v) preset to have a coil-type shape; (vi) preset to have a kinked shape; and (vii) connected at its second end to a contact, which breaks free from the second conductor and opens a circuit.

17. The thermal protection device of claim 16, wherein the second conductor includes first and second separated portions, the contact breaking free from the first and second separated portions, the circuit opened between the two portions.

18. A thermal protection device comprising:
an insulative housing;
first and second conductors positioned on first and second ends of the housing, respectively;
a shape memory alloy member having a first end fixed to the first conductor, a second end fixed to the second conductor, and at least one point of weakness along the member, the member returning to a preset shape upon reaching its activation temperature so that the member ruptures at least substantially at the point of weakness and opens a circuit.

19. The thermal protection device of claim 18, wherein the shape memory alloy member is at least one of: (i) coated with a conductive material to decrease electrical resistance; (ii) annealed to form its preset shape; (iii) made of a nickel-titanium alloy; (iv) configured to have an activation temperature of about 60° C. to about 100° C.; (v) preset to have a coil-type shape; and (vi) preset to have a kinked shape.

20. The thermal protection device of claim 18, wherein the at least one weak spot is at least one of: (i) located at least substantially centrally on the member; (ii) comprised of one or more perforations; and (iii) comprised of one or more thinned area along the member.

21. The thermal protection device of claim 18, which is surface mountable via at least one of: clips, pin sockets, conductive adhesive, and soldering with adequate heat sinking of the first and second conductors.

22. The thermal protection device of claim 18, which is configured to operate with the circuit, which circuit is at least one of: (i) provided on a printed circuit board circuit; (ii) in electrical communication with a fuse; (iii) in thermal communication with a heating element; (iv) in electrical communication with a voltage source; and (v) in electrical communication with a load.

23. A thermal protection device comprising:
an insulative housing;
first and second conductors positioned on first and second ends of the housing, respectively; and
a shape memory alloy member having a first end and a second end, the member returning to a preset shape upon reaching its activation temperature so that the first and second ends of the member complete a circuit that is in electrical communication with the first and second conductors.

24. The thermal protection device of claim 23, which is surface mountable via at least one of: clips, pin sockets, conductive adhesive, and soldering with adequate heat sinking of the first and second conductors.

25. The thermal protection device of claim 23, which is configured to operate with the circuit, the circuit being at least one of: (i) provided on a printed circuit board circuit; (ii) in electrical communication with a fuse; (iii) in thermal communication with a heating element; (iv) in electrical communication with a voltage source; and (v) in electrical communication with a load.

26. The thermal protection device of claim 23, wherein the shape memory alloy member is at least one of: (i) coated with a conductive material to decrease electrical resistance; (ii) annealed to form its preset shape; (iii) made of a nickel-titanium alloy; (iv) configured to have an activation temperature of about 60° C. to about 100° C.; (v) preset to have an uncoiled or unkinked shape; (vi) formed after annealing to have a coiled shape; (vii) formed after annealing to have a kinked shape; (viii) connected at one or both of the first and second ends to a contact, the contact contacting one of the first and second conductors to complete the circuit; (ix) connected at one of the first and second ends to one of the first and second conductors respectively.

27. The thermal protection device of claim 26, wherein one of the first and second conductors includes first and second separated portions, the contact contacting the first and second portions, the circuit completed by bridging the two portions.

28. A thermal protection device comprising:
an insulative housing;
first and second conductors positioned on first and second ends of the housing, respectively;
a spring having a first end and a second end; and
a material that holds the spring in a compressed state so that the first and second ends of the spring do not contact the first and second conductors, respectively, the material deforming upon reaching an activation temperature so that the spring uncoils and the first and second ends of the spring contact the first and second conductors.

29. The thermal protection device of claim 28, wherein the material is at least one of: (i) paraffin; (ii) a low melting temperature polymer; (iii) configured to encase the spring in the compressed state; and (iv) configured as a plug placed in series with the spring to hold the spring in the compressed state;

30. The thermal protection device of claim 28, which is configured to operate with a circuit, the circuit being at least one of: (i) provided on a printed circuit board circuit; (ii) in electrical communication with a fuse; (iii) in thermal communication with a heating element; (iv) in electrical communication with a voltage source; and (v) in electrical communication with a load.

31. The thermal protection device of claim 28, wherein the spring is made from at least one material selected from the group consisting of: stainless steel, chrome vanadium and nickel coated stainless steel.

32. A thermal protection circuit comprising:
a voltage source;
a load;
a fuse placed in series with the voltage source and the load; and
a thermal protection device placed in parallel with the load, the thermal protection device upon reaching an activation temperature causing a short circuit resulting in an opening of the fuse.

33. The thermal protection circuit of claim 32, wherein the thermal protection device includes a shape memory alloy member.

34. The thermal protection circuit of claim 32, wherein the thermal protection device is normally open.
